(19) United States
(12) Patent Application Publication
(10) Pub. No.: US 2004/0117391 A1
(43) Pub. Date: Jun. 17, 2004

(54) Organization information recording apparatus, and organization information analyzing apparatus

(76) Inventor: Ikuo Koumaru, Chiba (JP)

Correspondence Address: JAY H. MAIOLI, Cooper & Dunham LLP, 1185 Avenue of the Americas, New York, NY, 10036, US

(21) Appl. No.: 10/695,465

(22) Filed: Oct. 28, 2003

(30) Foreign Application Priority Data
Oct. 30, 2002 (JP) P2002-315320

(51) Int. Cl. G06F 7/00

(52) U.S. Cl. 707/100

(57) ABSTRACT

An organization information recording apparatus for recording organization structures which are formed by combining a plurality of acting organization objects is proposed wherein the organization information recording apparatus comprises an acting organization object recording unit for individually recording the acting organization objects which equip with an input information, an output information, an auxiliary input information, and an auxiliary output information as properties, and an acting organization object mode designating unit including an input information designating unit, an output information designating unit, an auxiliary input information designating unit, and an auxiliary output information designating unit for setting property of a specified object recorded in the acting organization object recording unit.

### CROSS REFERENCE TO RELATED APPLICATION

This application claims priority from Japanese Priority Document No. 2002-315320, filed on Oct. 30, 2002 with the Japanese Patent Office, which document is hereby incorporated by reference.

### BACKGROUND OF THE INVENTION

1. Filed of the Invention

The present invention relates to an organization information analyzing apparatus utilized when carrying out a study of measures for an efficiency analysis and an efficiency improvement of an organization, an organization information analyzing apparatus necessary for constituting the organization information analyzing apparatus, a program therefore, and an information recording medium on which the program is recorded, wherein, such as a business enterprise, a structured body constituted by combining a plurality of acting organizations is arranged to carry out outputting at least one result.

Particularly, the present invention relates to the organization information analyzing apparatus, the organization information analyzing apparatus, the program therefore, and the information recording medium on which the program is recorded, wherein a design of the Supply Chain Management (hereinafter simply referred to as SCM) can be carried out more clearly by enabling the designation of items for an input and an output, and by enabling the designation of an auxiliary input and an auxiliary output independently regarding each organization.

2. Description of the Related Art

In a business enterprise or the like, various methods are utilized for reconstructing functions of the organization by clarifying a role and a responsibility of the segmented organization. The Supply Chain Management is a representative management method, and is reported by various media, wherein a business activity from upstream to downstream such as ordering between customer, material procurement, inventory management, and transportation of product is comprehensively managed by using a computer.

In the Supply Chain Management now being introduced, acting organizations where input information and output information are defined are connected along with a stream of their business works, and their evaluations are to be carried out. This is described with reference to FIG. 7. FIG. 7 shows one example where the business work of a soba restaurant is in order using a conventional SCM method, wherein the business work of the soba restaurant is expressed by purchasing at the beginning, stocking ingredient, taking out the ingredient by ordering, cooking/setting out, carrying out tray service to a customer, collecting money, collecting/washing tableware after eating by the customer, and cleaning inside of the soba restaurant.

However when the business work is designed using such conventional SCM method as shown in FIG. 7, the customer may recognize respective values regarding the cooking, the setting out (setting out tempura), and the tray service, but they do not directly influence the level of a customer satisfaction, so that there has been a problem that even if these are set out as a model, the model may lack the clearness on the SCM method.

Accordingly, the inventors of the preset invention treated as the essence of the SCM method is “what kind of added value is added” and “how they are added” in the section constituting the business activity in the business activity, for example, and each section cannot be analyzed only by input information and output information, but auxiliary input information and auxiliary output information supporting the input information and the output information are necessary for the analysis, and accordingly, the inventors made a conclusion that the essence of the SCM method is made clear and an accurate SCM analysis is possible.

### SUMMARY OF THE INVENTION

It is one of aspects of the present invention to propose an organization information analyzing apparatus, an organization information recording apparatus, a program therefore, and an information recording medium capable of carrying out a design of a supply chain management.

According to a first aspect of the present invention, an organization information recording apparatus for recording organization structures which are formed by combining a plurality of acting organization objects comprises an acting organization object recording unit for individually recording the acting organization objects which equip with an input information, an output information, an auxiliary input information, and an auxiliary output information as properties, and an acting organization object mode designating unit including an input information designating unit, an output information designating unit, an auxiliary input information designating unit, and an auxiliary output information designating unit for setting property of a specified object recorded in the acting organization object recording unit. In this case, the properties of the acting organization objects recorded in the acting organization object recording unit may be only the input information and the auxiliary input information, or may be only the output information and the auxiliary output information.

In the organization information recording apparatus of the present invention, not only the input information and the output information but also information relating to the acting organization objects other than the input information and the output information, namely the auxiliary input information and the auxiliary output information are employed as the properties of the acting organization objects, thereby, a model by the SCM method where “what kind of added value are added” and “how they are added” of the respective object are made clear, so that the accuracy of the SCM analysis is improved.

In the organization information recording apparatus either the input information and the auxiliary input information, or the output information or the auxiliary output information are made exchangeable regarding the properties relating to the input information, the output information, the auxiliary input information, and the auxiliary output information.

If the input information and the auxiliary input information or the output information and the auxiliary output information are constituted as exchangeable as mentioned above, the combination for the modeling by the SCM method becomes variety and the accuracy of the SCM analysis is improved.

According to the second aspect of the present invention, an organization information analysis apparatus for analyzing the organization which is expressed by combining a plurality of acting organization objects is proposed, wherein the organization information analysis apparatus comprises an acting organization object recording unit for individually recording the acting organization objects which equip with an input information, an output information, an auxiliary input information, and an auxiliary output information as properties, an acting organization object mode designating unit including an input information designating unit, an output information designating unit, an auxiliary input information designating unit, and an auxiliary output information designating unit for setting property of a specified object recorded in the acting organization object recording unit, and an acting organization object analyzing unit for analyzing a performance relating to a combination of a plurality of acting organization objects in accordance with the relation between input information property and an output information property based on the objects recorded in the acting organization object recording unit.

In this case, the properties of the acting organization object recorded in the acting organization object recording unit may only be an input information and an auxiliary input information or may only be an output information and an auxiliary output information.

In the organization information analyzing apparatus of the present invention, not only the input information and the output information but also information relating to the acting organization objects other than the input information and the output information, namely the auxiliary input information and the auxiliary output information are employed as the properties of the acting organization objects, thereby, a model by the SCM method where “what kind of added value are added” and “how they are added” of the respective object are made clear, so that the accuracy of the SCM analysis is improved.

In the present invention as mentioned above, it is able to constitute for the acting organization object to be further equipped with an activity contents property expressing contents of activity and to carry out a link appropriateness test regarding a plurality of acting organization objects obtained based on the property of the acting organization object.

Further the activity contents property is provided, and thereby, it is able to inspect a linkable object and an object not suitable for the link when linking operation by inspecting the link appropriateness test upon linking the acting organization objects using the activity contents property, and thereby, the model by the SCM method becomes clear, so that the accuracy of the SCM analysis is improved.

According to a third aspect of the present invention, a program or an information recording medium on which the program is recorded is proposed, wherein a program or an information recording medium have a computer function as the organization information recording apparatus or the organization information analyzing apparatus based on the first and the second aspects of the present invention.

As described above, according to the present invention, it is possible to preset an organization information analyzing apparatus, an organization information recording apparatus, a program, and an information recording medium capable of carrying out the design of the Supply Chain Management more precisely.

### BRIEF DESCRIPTION OF THE DRAWINGS

FIG. 1 shows a block diagram of one embodiment of an organization information analyzing apparatus according to the present invention;

FIG. 2 shows a block diagram of one embodiment of an organization information recording apparatus according to the present invention;

FIG. 3 shows processing contents in an object linking unit of one of embodiment of an object analyzing unit according to the present invention;

FIG. 4 shows simulation result by one embodiment of an organization information analyzing apparatus according to the present invention;

FIG. 5 shows one example of an added value of an acting organization object according to the present invention;

FIG. 6 shows a continuity map of the acting organization object according to the present invention; and

FIG. 7 shows a result obtained by analyzing business work of a soba restaurant using a conventional SCM method.

### DETAILED DESCRIPTION OF THE PREFERRED EMBODIMENTS

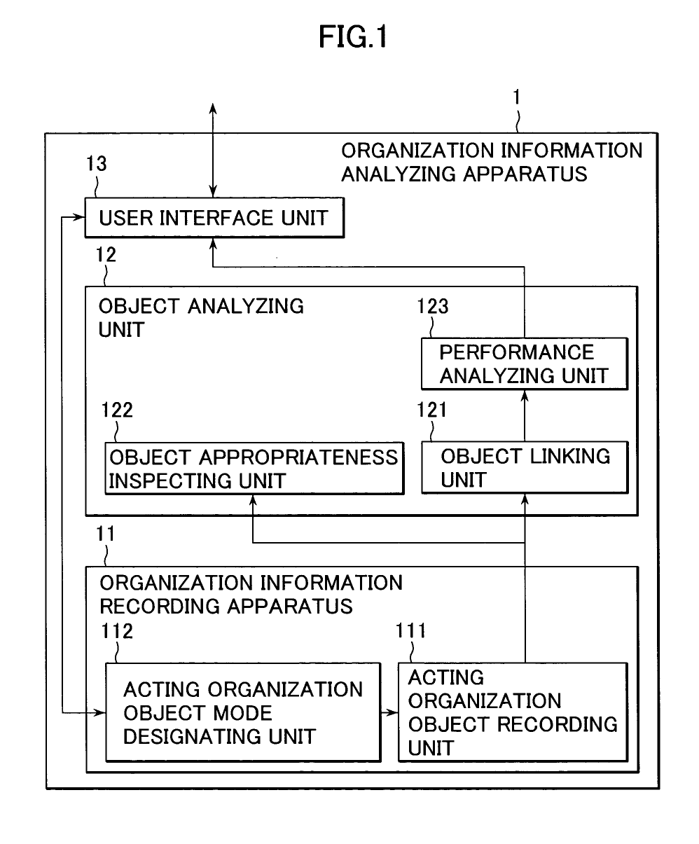

As shown in FIG. 1, an organization information analyzing apparatus 1 according to the present invention comprises an organization information recording apparatus 11, an object analyzing unit 12, and a user interface unit 13. The organization information recording apparatus 11 comprises an acting organization object recording unit 111, and an acting organization object mode designating unit 112.

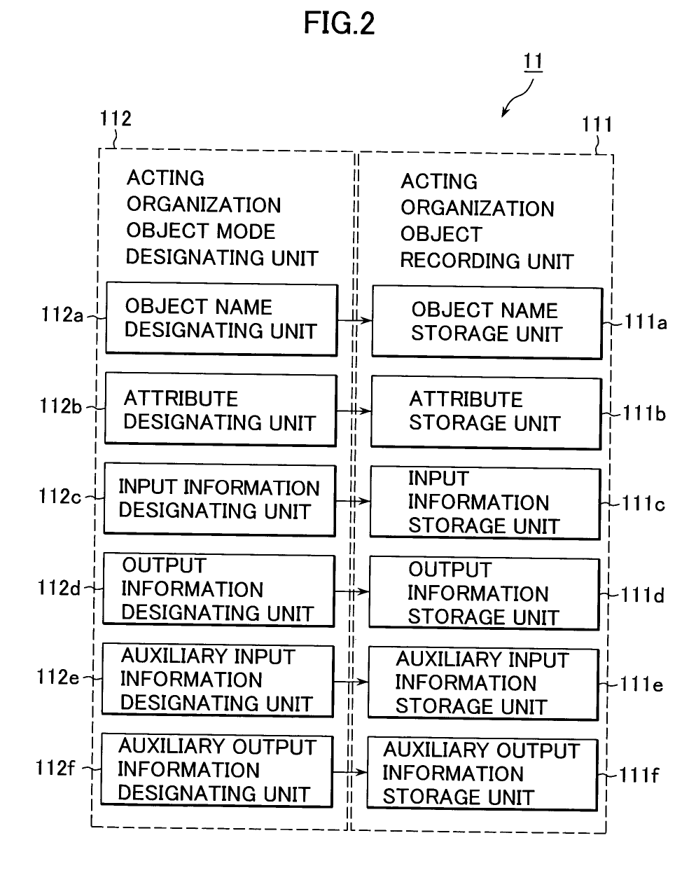

Among them, the acting organization object recording unit 111 is arranged to record at least one of the acting organization objects. And further, the acting organization object recording unit 111 comprises an object name storage unit 111a, an attribute storage unit 111b, an input information storage unit 11c, an output information storage unit 111d, an auxiliary input information storage unit 111e, and an auxiliary output information storage unit 111f as shown in FIG. 2.

Further, the acting organization object mode designating unit 112 comprises an object name designating unit 112a, an attribute designating unit 112b, an input information designating unit 112c, an output information designating unit 112d, an auxiliary input information designating unit 112e, and an auxiliary output information designating unit 112f as shown in FIG. 2.

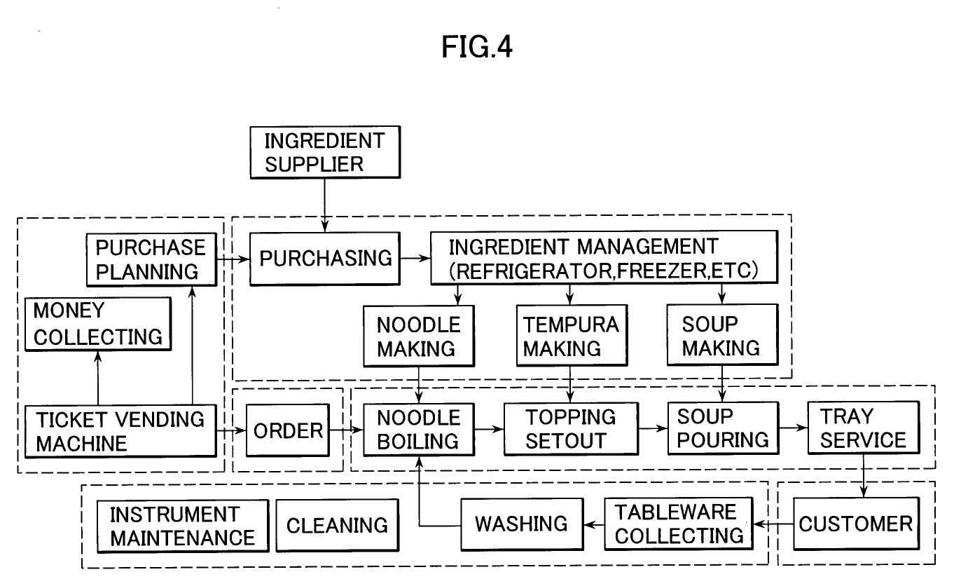

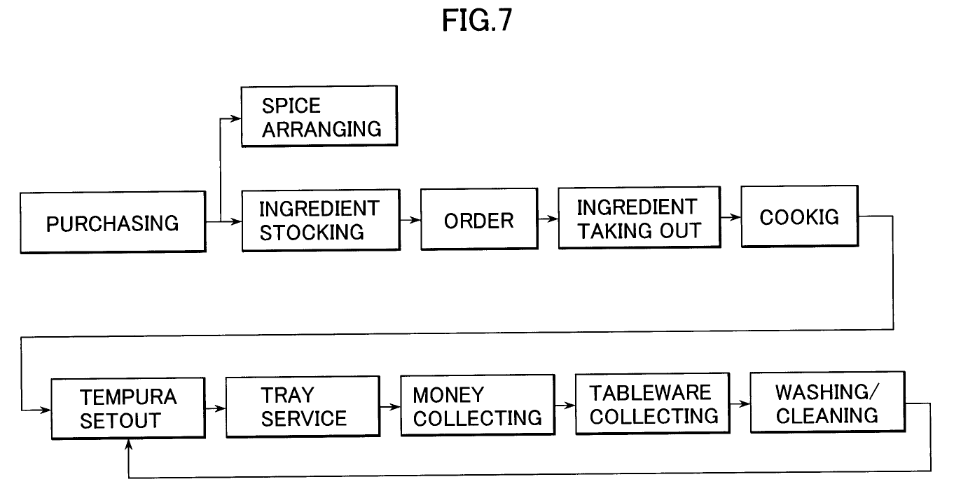

In this case, an object name designated by the object name designating unit 112a means respective content of activities constituting the business activity, if a business enterprise is taken as an example. In case of a soba restaurant such as shown in FIG. 4, respective content of activity such as ticket vending, money collecting, purchase planning, purchasing, ingredient management, noodle making, tempura making, soup making, order, . . . , washing, cleaning, and instrument maintenance correspond to respective object name. In case of a soba restaurant as shown in FIG. 7, respective content of activity such as purchasing, ingredient stocking, order, ingredient taking out, cooking, . . . , tableware collecting, and washing/cleaning correspond to respective object name.

Further, an attribute (activity contents property) designated by the attribute designating unit 112b means a classified object depending on whether the information (I) is dominant, the product (P) is dominant, or the service (S) is dominant. The objects which are the contents of activity of a business enterprise are able to be classified into three, namely whether the information (I) is mainly dominant, the product (P) is mainly dominant, or the service (S) is mainly dominant. In this example, this is defined as an attribute of the object, and a link appropriateness of the respective object is inspected at a object linking unit 121 and an object appropriateness inspecting unit 122 (they are described later) based on this attribute.

In the example of the soba restaurant shown in FIG. 4, the attributes of a ticket vending machine, money collecting, purchase planning, and order correspond to the information (I), the attributes of tray service, a customer, and tableware collecting correspond to the service (S), and the attributes of other objects correspond to the product (P). Further, in the example of the soba restaurant shown in FIG. 7, the attributes of order, and money collecting correspond to the information (I), the attribute of tray service corresponds to the service (S), and the attributes of other objects correspond to the product (P).

The input information designated by the input information designating unit 112c means the object A which is continuous to an object B, and is immediately before the object B (in other words, the object B is started by a direct trigger from a certain object A), and in the noodle boiling object of the soba restaurant as shown in FIG. 4, for example, the noodle boiling work is carried out when received the order, so that the input information is the order object. In the same way, a topping setout work is carried out after a noodle boiling work in the topping setout object, and accordingly, the input information is the noodle boiling object in this case.

On the contrary, an output information designated by the output information designating unit 112d means the object C which is continuous to an object B, and is immediately after the object B (in other words, the object C is started by a direct trigger from a certain object B), and in the noodle boiling object of the soba restaurant as shown in FIG. 4, for example, the topping setout work is carried out after the noodle boiling work, so that the output information is the topping setout object. In the same way, the soup pouring work is carried out after the topping setout work in the topping setout object, and accordingly, the output information is the soup pouring object.

The acting organization object mode designating unit 112 of the present embodiment further comprises particularly the auxiliary input information designating unit 112e and the auxiliary output information designating unit 112f. The auxiliary input information designated by the auxiliary input information designating unit 112e means the object D other than the object A among objects of the previous step (including the case where the step is circulating) continuous to the object B (in other words, the object D is started by an indirect trigger from a certain object B). In the noodle boiling object of the soba restaurant as shown in FIG. 4, for example, the noodle boiling work is carried out when receiving the order, but the noodle making work is also necessary before the noodle boiling work, so that the auxiliary input information becomes the noodle making object. Further after the customer finishes the meal, the tableware is collected, and it is prepared for a next noodle boiling after washing the tableware, so that the washing work is also necessary before the noodle boiling work. Accordingly, the washing object also becomes one of the auxiliary input information of the noodle boiling object. In the same way, the topping setout work is carried out after the noodle boiling work in the topping setout object, but it is necessary to carry out a tempura making work before the topping setout work, so that the auxiliary input information of the topping setout object becomes the tempura making object. Further the input information of the soup pouring object is the topping setout object, and the auxiliary input information is the soup making object.

On the contrary, the auxiliary output information designated by the auxiliary output information designating unit 112f means the object E (in other words, the object E is started by an indirect trigger from certain object B) which is other than the object C immediately after the object B among objects of the later steps (including the case where the step is circulating) continuing to the object B. In the ticket vending object of the soba restaurant in FIG. 4, when a customer buys a ticket from a ticket vending machine, this directly continues to the ordering object, and simultaneously the money collecting is carried out, and further the purchase planning is also started, so that the auxiliary output information of the ticket vending object are the money collecting object, and the purchase planning object.

By employing these auxiliary input information and the auxiliary output information, they appears as added values of the input information and the output information, and the type of the added value and the way of addition are made clear, so that the analysis by the SCM method becomes more precisely.

In the example of the soba restaurant by a conventional SCM method in FIG. 7, the objects are linked only by the input information and the output information, but the example of the soba restaurant by the SCM method of the present invention as shown in FIG. 4, the objects are linked by the auxiliary input information and the auxiliary output information in addition to the input information and the output information.

In the conventional method shown in FIG. 7, respective object of taking out the ingredient after the order, the cooking and the setting out tempura are linked as one stream, so that it is not able to analyze the contents of the cooking object in detail. Accordingly, it is not clear the timing and the way to cook noodle, tempura, and soup necessary for soba, and a cold tempura, a cold soup, or a cold noodle might be served to a customer.

On the contrary, in the method of the present invention shown in FIG. 4, the cooking objects are further segmented, and the object such as the noodle making, the tempura making, and the soup making which are the auxiliary input information are linked to respective segmented cooking object, so that it is able to analyze the timings of the respective object such as the noodle boiling, the topping setout, and the soup pouring relative to the respective object such as the noodle making, the tempura making, and the soup making. Accordingly, it is able to serve a hot noodle to a customer by setting out a fresh and hot tempura on a fresh noodle and pouring a fresh and hot soup.

As described above, by adding the auxiliary input information and the auxiliary output information, it is able to clear the added values (in the above example, it is able to serve a hot noodle to a customer) of the respective object, so that it is able to carry out the analysis by the SCM method more precisely. In this case, depending on the object, the auxiliary input information and the auxiliary output information are not designated, or either one of them is designated.

Back to FIG. 1, the object name, the attribute, the input information, the output information, the auxiliary input information, and the auxiliary output information designated by respective object name designating unit 112a, the attribute designating unit 112b, the input information designating unit 112c, the output information designating unit 112d, the auxiliary input information designating unit 112e, and the auxiliary output information designating unit 112f of the acting organization object mode designating unit 112 are recorded to respective object name storage unit 111a, the attribute storage unit 111b, the input information storage unit 111c, the output information storage unit 111d, the auxiliary input information storage unit 111e, and the auxiliary output information storage unit 111f of the acting organization object recording unit 111. This is depicted in FIG. 2.

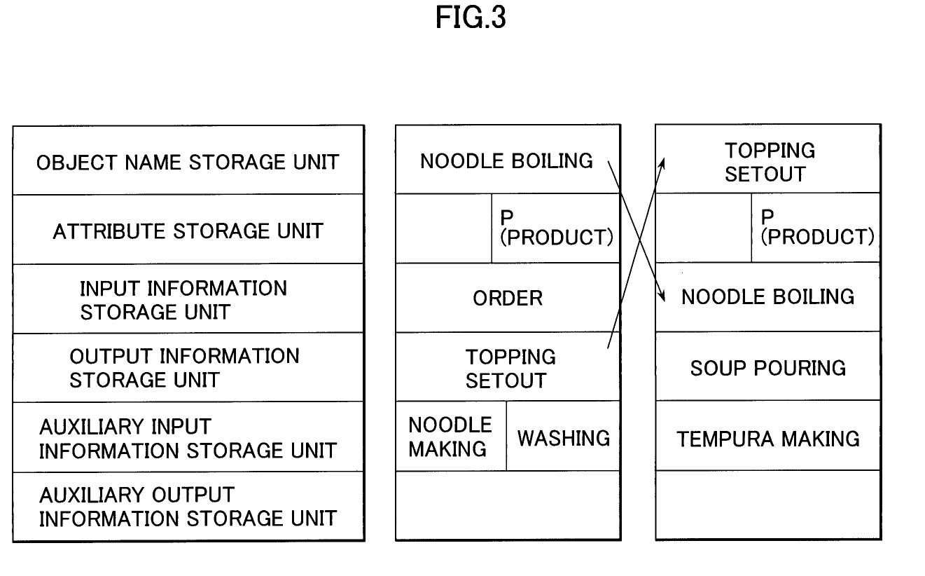

On the other hand, the object linking unit 121 of the object analyzing unit 12 shown in FIG. 2 reads out respective object recorded in the acting organization object recording unit 111, and links the read out objects as shown in FIG. 3 with reference to the input information storage unit 111c, the auxiliary input information storage unit 111e, the output information storage unit 111d, and the auxiliary output information storage unit 11f. For example, a candidate for the object B to be linked to a later step of an object A is an object stored in the output information storage unit 111d or the auxiliary output information storage unit 111f of the object A, and among candidate objects, the object B where the object A is stored in the input information storage unit 111c or the auxiliary input information storage unit 111e of the object becomes a linkable object. In case of the example shown in FIG. 3, the topping setout object is stored in the output information storage unit 111d of the noodle boiling object, and on the contrary, the noodle boiling object is stored in the input information storage unit 11c of the ingredient setout object, so that it is possible to link the topping setout object to the noodle boiling object.

Further in this example, in case of linking operations as described above, the object appropriateness inspecting unit 122 inspects whether the object to be linked is appropriate or not. The object appropriateness inspecting unit 122 inspects the appropriateness in accordance with the following rules. As mentioned above, the attribute of the respective object is classified into the information (I), the product (P), and the service (S), when the object having any of these three attributes is linked, there exists a combination having a continuity, and a combination not having a continuity.

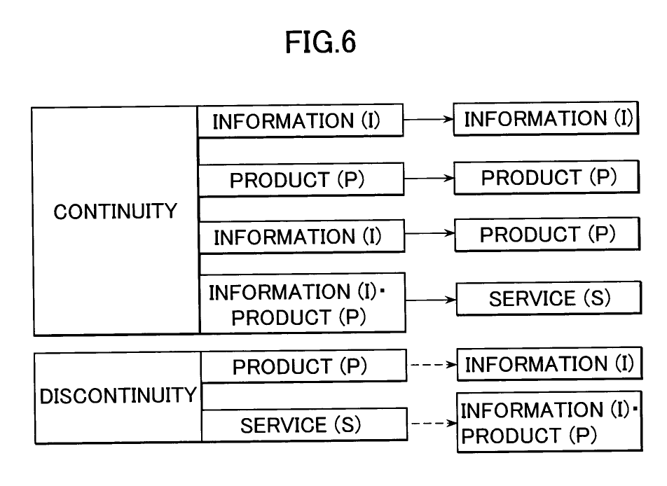

For example as shown at top of FIG. 6, when an object where the attribute is the information (I) is linked to an object where the attribute is the information (I), it is able to transfer the information (I) of the previous step to an object of a later step after working and processing, which is something like the case where the money collecting object or the purchase planning object is linked to the ticket vending object as shown in FIG. 4, so that there is a continuity between objects.

Further when an object where the attribute is the product (P) is linked to an object where the attribute is the product (P), it is able to transfer the product (P) of the previous step to an object of a later step after working and processing, which is something like the case where the topping setout object is linked to the noodle boiling object as shown in FIG. 4, so that there is a continuity between objects.

Further when an object where the attribute is the product (P) is linked to an object where the attribute is the information (I), it is able to work and process the product (P) relating to a later step based on the information (I) of the previous step, which is something like the case where the noodle boiling object is linked to the order object as shown in FIG. 4, so that there is a continuity between objects.

Further when the object where the attribute is the service (S) is linked to the object where the attribute is a mixture of the product (P) and the information (I), the service object of the later step is able to be exploded based on the product (P) and the information (I) of the previous step, which is something like the case where the tray service object (the attribute is service (S)) is linked to the ordering object (the attribute is information (I)) and the soup pouring object (the attribute is product (P)) as shown in FIG. 4, so that there is a continuity between objects.

On the contrary, as shown at a bottom of FIG. 6, when an object where the attribute is the information (I) is linked to an object where the attribute is the product (P), the information (I) can not be obtained from the product (P), so that there is no continuity between the objects. Also, when an object where the attribute is a mixture of the information (I) and the product (P) is linked to an object where the attribute is the service (S), any of the product (P) and the information (I) can not be obtained, so that there is no continuity between the objects.

The continuity/discontinuity among objects as mentioned above is verified in advance, and the object continuity map is stored in the object appropriateness inspecting unit 122. Further, it is inspected whether the combination of the objects linked at the object linking unit 121 is a combination having a continuity or a combination not having a continuity with reference to the object continuity map, and the combination of the objects having no continuity is disabled to be linked, or when linked, the warning of this meaning is generated.

By providing the object appropriateness inspecting unit 122, it is possible to exclude the object which is not linked appropriately in advance of the performance analysis, so that it becomes possible to restrictively select a proper model for the performance analysis among candidate models.

Again back to FIG. 1, the performance analyzing unit 123 is linked to the object linking unit 121, and the performance of the object model where the link is verified as appropriate is analyzed in the object appropriateness inspecting unit 122. This performance analysis is executed in order to evaluate desired evaluation items, that is, cost such as a labor cost, a material cost, a management cost, or a logistic cost, smoothness or others such as a flow of a worker or logistic, or others, and the other target items. The result analyzed by the performance analyzing unit 123 is transmitted to a user via the user interface unit 13. Here, the user interface unit 13 carries out a transmission/reception of data among user terminal apparatuses connected to the organization information analyzing apparatus 1 of this embodiment via the communication network, or the like.

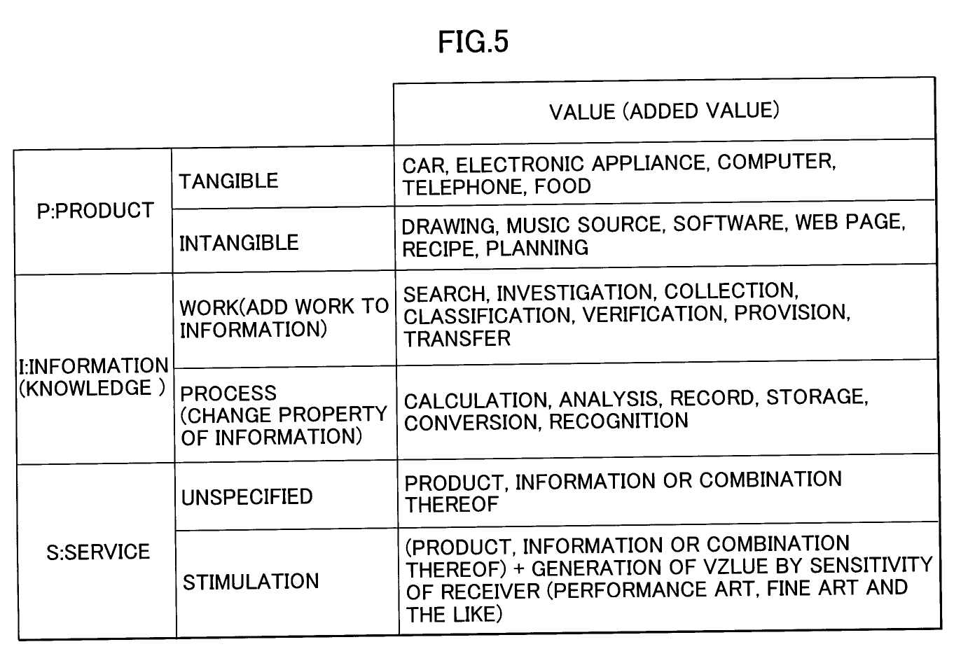

Then an example for analyzing the activity of the soba restaurant by the organization information analyzing apparatus 1 is explained. At first, activity objects of the soba restaurant are designated to respective designating units 112a to 112f of the acting organization object mode designating unit 112 as shown in FIG. 1. In this case as shown in FIG. 5, items to be added values are selected in accordance with the activity contents attributes (P), (I), and (S) of the objects, and are used as the input information, the output information, the auxiliary input information, and the auxiliary output information. Each property designated by the respective designating units 112a to 112f of the acting organization object mode designating unit 112 are stored in the respective storage units 111a to 111f of the acting organization object recording unit 111 as shown in FIG. 2.

Then as shown in FIG. 3, respective object recorded in the acting organization object recording unit 111 is read out, and linked to each other with reference to the input information storage unit 111c, the auxiliary input information storage unit 111e, the output information storage unit 111d, and the auxiliary output information storage unit 111f of the respective object. Simultaneously with this, the object appropriateness inspecting unit 122 inspects the appropriateness of the link with reference to the object attribute storage unit 111b of the linked two objects and the continuity map of objects shown in FIG. 6, and if the link lacks the appropriateness, then it warns the fact with warning display or warning sound, or makes the link invalid with the warning display.

One example of thus linked object models for the soba restaurant is shown in FIG. 4, and in this embodiment, in addition to the input information and the output information, the auxiliary input information and the auxiliary output information are employed as the property of the object, so that the analysis of the object becomes more accurate compared to the conventional model in FIG. 7. In the link such as purchasing→stocking ingredient→order as shown in FIG. 7, for, example, there is no link between stocking ingredient (P)→order (I) in particular, but in the example shown in FIG. 4, the order and the purchasing are linked by the objects aligned in parallel, and linked to the object continued to the ordering object through the ingredient management based on the purchasing as the auxiliary input information, so that the continuity of the object is secured.

Further as described above, the object of the cooking is segmented, and the auxiliary input information and the auxiliary output information are utilized, so that it is able to adjust the timings for the noodle boiling, the topping setout, and the soup pouring to set up model for serving a hot noodle to a customer. Then the object model which is linked by the object linking unit 121, and verified by the object appropriateness inspecting unit 122 as the link is appropriate is transmitted to the performance analyzing unit 123, and the performance of the object model is analyzed there. This performance analysis is evaluated based on a desired evaluation item such as a cost including a labor cost, an ingredient cost, a management cost, or a logistic cost, a smoothness or others such as a flow of a worker or a logistic, or other target items. Lastly, the result analyzed at the performance analyzing unit 123 is transmitted to a user via the user interface unit 13.

Further, the above mentioned embodiment is described so as to make it easy to understand the present invention, and is not for limiting the scope of the present invention. Accordingly, each element disclosed in the above embodiment may include any of alternatives or equivalents that belong to a scope of the present invention.

For example, in the above mentioned embodiment, the object name, the attribute, the input information, the output information, the auxiliary input information and the auxiliary output information are employed as the properties constituting the acting organization object recording unit 111 and the acting organization object unit mode designating unit 112. But either one of the input information and the auxiliary input information or the output information and auxiliary output information is able to be abbreviated depending on the construction of the user terminal apparatus. In this case, the abbreviated information may be directly transferred from the user terminal apparatus to the object linking unit 121 and the object appropriateness inspecting unit 122.

What is claimed is:

1. An organization information recording apparatus for recording organization structures which are formed by combining a plurality of acting organization objects comprising:
an acting organization object recording unit for individually recording said acting organization objects which equip with an input information, an output information, an auxiliary input information, and an auxiliary output information as properties; and
an acting organization object mode designating unit including an input information designating unit, an output information designating unit, an auxiliary input information designating unit, and an auxiliary output information designating unit for setting property of a specified object recorded in said acting organization object recording unit.

2. The organization information recording apparatus as cited in claim 1, wherein
either said input information and said auxiliary input information, or said output information or said auxiliary output information are made exchangeable regarding properties relating to said input information, said output information, said auxiliary input information, and said auxiliary output information.

3. An organization information recording apparatus for recording organization structures which are formed by combining a plurality of acting organization objects comprising:
an acting organization object recording unit for individually recording said acting organization objects which equip with an input information, and auxiliary input information; and
an acting organization object mode designating unit including an input information designating unit, and an auxiliary input information designating unit for setting property of a specified object recorded in said acting organization object recording unit.

4. An organization information recording apparatus for recording organization structures which are formed by combining a plurality of acting organization objects comprising:
an acting organization object recording unit for individually recording said acting organization objects which equip with an output information, and auxiliary output information; and
an acting organization object mode designating unit including an output information designating unit, and an auxiliary output information designating unit for setting property of a specified object recorded in said acting organization object recording unit.

5. An organization information analysis apparatus for analyzing an organization which is expressed by combining a plurality of acting organization objects comprising:
an acting organization object recording unit for individually recording said acting organization objects which equip with an input information, an output information, an auxiliary input information, and an auxiliary output information as properties;
an acting organization object mode designating unit including an input information designating unit, an output information designating unit, an auxiliary input information designating unit, and an auxiliary output information designating unit for setting property of a specified object recorded in said acting organization object recording unit; and
an acting organization object analyzing unit for analyzing a performance relating to a combination of a plurality of acting organization objects in accordance with the relation between input information property and an output information property based on the objects recorded in said acting organization object recording unit.

6. An organization information analysis apparatus for analyzing organization which are expressed by combining a plurality of acting organization objects comprising:
an acting organization object recording unit for individually recording said acting organization objects which equip with an input information, and an auxiliary input information as properties;
an acting organization object mode designating unit including an input information designating unit and an auxiliary input information designating unit for setting property of a specified object recorded in said acting organization object recording unit; and
an acting organization object analyzing unit for analyzing a performance relating to a combination of a plurality of acting organization objects in accordance with the input information property based on the objects recorded in said acting organization object recording unit.

7. An organization information analysis apparatus for analyzing organization which are expressed by combining a plurality of acting organization objects comprising:
an acting organization object recording unit for individually recording said acting organization objects which equip with an output information, and an auxiliary output information as properties;
an acting organization object mode designating unit including an output information designating unit and an auxiliary output information designating unit for setting property of a specified object recorded in said acting organization object recording unit; and
an acting organization object analyzing unit for analyzing a performance relating to a combination of a plurality of acting organization objects in accordance with the output information property based on the objects recorded in said acting organization object recording unit.

8. The organization information analysis apparatus as cited any one of claim 5, claim 6, and claim 7, wherein
said acting organization object equips with an activity contents property expressing contents of activity;
said acting organization analyzing unit carries out a link appropriateness inspection with regard to a plurality of acting organization object obtained based on the properties of said acting organization object.

9. A computer program which functions a computer as the organization information recording apparatus as cited in any one of claims 1 to 4.

10. A computer program which functions a computer as the organization information analysis apparatus as cited in any one of claims 5 to 8.

11. A recording medium to which said computer program as cited claim 9 or claim 10 is recorded.
